(19) United States
(12) Patent Application Publication
(10) Pub. No.: US 2022/0097490 A1
(43) Pub. Date: Mar. 31, 2022

(54) AIR VENT SYSTEM

(71) Applicant: Shanghai Yanfeng Jinqiao Automotive Trim Systems Co. Ltd., Novi, MI (US)

(72) Inventor: Junwei ZHANG, Shanghai (CN)

(21) Appl. No.: 17/546,673

(22) Filed: Dec. 9, 2021

Related U.S. Application Data
(63) Continuation-in-part of application No. PCT/CN2020/095060, filed on Jun. 9, 2020.

(30) Foreign Application Priority Data
Jun. 10, 2019 (CN) 201910496360.8

(51) Int. Cl. B60H 1/34

(52) U.S. Cl. CPC B60H 1/3414; B60H 2001/3478

(57) ABSTRACT

An air vent assembly for a vehicle interior is disclosed. The assembly may comprise an inner airflow guide, an outer airflow guide and drive mechanism comprising an inner airflow mechanism to actuate the inner airflow guide and an outer airflow mechanism to actuate the outer airflow guide. The drive mechanism when operated in a first direction will actuate the inner airflow mechanism and when operated in a second direction will actuate both the inner airflow mechanism and the outer airflow mechanism. The drive mechanism may comprise a clutch mechanism to engage the inner airflow mechanism when operated in the first direction and to engage both the inner airflow mechanism and the outer airflow mechanism when operated in the second direction. The inner airflow guide may comprise a vertical blade set; the outer airflow guide may comprise a horizontal blade set. The drive mechanism is operated by motor and rotating shaft.

### CROSS-REFERENCE TO RELATED APPLICATIONS

The present application is a continuation-in-part of PCT/International Patent Application No. PCT/CN2020/095060 filed Jun. 9, 2020, which claims the benefit of Chinese Patent Application No. 201910496360.8 filed Jun. 10, 2019.

The present application claims priority to and incorporates by reference in full the following patent applications: (a) Chinese Patent Application No. 201910496360.8 filed Jun. 10, 2019; (b) PCT/International Patent Application No. PCT/CN2020/095060 filed Jun. 9, 2020.

The present application is related to the following patent applications: (a) Chinese Patent Application No. 201910496260.5 filed Jun. 10, 2019; (b) PCT/International Patent Application No. PCT/CN2020/094333 filed Jun. 4, 2020.

### FIELD

The present invention relates to an air vent system for a vehicle interior.

### BACKGROUND

It is known to provide an air vent system for a vehicle interior.

It would be advantageous to provide an improved air vent assembly/system with a set of airflow guides configured to be actuated/directed by operation of a drive mechanism with a single motor.

### SUMMARY

The present invention relates to an air vent assembly configured for a vehicle interior comprising an inner airflow guide, an outer airflow guide and a drive mechanism comprising an inner airflow mechanism configured to actuate the inner airflow guide and an outer airflow mechanism configured to actuate the outer airflow guide. The drive mechanism may be configured to be operated in a first direction and a second direction. The drive mechanism may be configured so that (1) when operated in the first direction the inner airflow mechanism is actuated and (2) when operated in the second direction the inner airflow mechanism is actuated and the outer airflow mechanism is actuated. The assembly may comprise a motor configured to operate the drive mechanism; the motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction. The drive mechanism may comprise a clutch assembly configured to engage at the drive mechanism so that (1) when operated in the first direction only the inner airflow mechanism is actuated and (2) when operated in the second direction both the inner airflow mechanism is actuated and the outer airflow mechanism is actuated. The clutch assembly may comprise an inner ring and an outer ring. The clutch assembly may comprise a one-way bearing. The inner airflow mechanism may comprise a gear and a connecting rod coupled to the inner airflow guide. The inner airflow mechanism may comprise a rack and pinion. The outer airflow mechanism may comprise a cam and a follower coupled to the outer airflow guide. The cam may comprise a spiral cam. The inner airflow guide may be configured to direct airflow in a first airflow direction and the outer airflow guide may be configured to direct airflow in a second airflow direction. The inner airflow guide may comprise an inner blade set comprising a plurality of blades; the outer airflow guide may comprise an outer blade set comprising a plurality of blades. The inner blade set may comprise a vertical blade set comprising a plurality of generally vertical blades; the outer blade set may comprise a horizontal blade set comprising a plurality of generally horizontal blades.

The present invention relates to an air vent system configured for a vehicle interior comprising an inner blade set comprising a plurality of blades, an outer blade set comprising a plurality of blades, a drive mechanism configured to be operated in a first direction and a second direction and a motor configured to operate the drive mechanism. The drive mechanism may comprise an inner blade mechanism configured to actuate the inner blade set. The drive mechanism may comprise an outer blade mechanism configured to actuate the outer blade set. The drive mechanism may comprise a clutch mechanism configured to engage the drive mechanism so that (1) when operated in the first direction only the inner blade mechanism is actuated and (2) when operated in the second direction both the inner blade mechanism is actuated and the outer blade mechanism is actuated. The clutch mechanism may comprise an inner ring and an outer ring; the clutch mechanism may be configured so that both the inner ring and the outer ring are engaged when the drive mechanism is operated in the second direction.

The present invention relates to an air vent assembly configured for a vehicle interior comprising a vertical blade set comprising a plurality of generally vertical blades, a horizontal blade set comprising a plurality of generally horizontal blades and a drive mechanism configured to be operated in a first direction and a second direction. The drive mechanism may comprise a vertical blade mechanism configured to actuate the vertical blade set. The drive mechanism may comprise a horizontal blade mechanism configured to actuate the horizontal blade set. The drive mechanism may comprise a clutch assembly configured to engage the drive mechanism so that (1) when operated in the first direction the vertical blade mechanism is actuated and (2) when operated in the second direction the vertical blade mechanism is actuated and the horizontal blade mechanism is actuated. The clutch assembly may be configured so that the drive mechanism is operated in the first direction to actuate only the vertical blade mechanism. The clutch assembly may be configured so that the drive mechanism is operated in the second direction both to actuate the vertical blade mechanism and to actuate the horizontal blade mechanism. The clutch assembly may be configured so that the drive mechanism is operated in the second direction to actuate the vertical blade mechanism and to actuate the horizontal blade mechanism synchronously with a one-to-one drive ratio. The assembly may comprise a motor configured to operate the drive mechanism; the motor may be configured to operate a shaft to operate the drive mechanism; operation of the drive mechanism in the first direction may comprise rotation of the shaft in the first direction and operation of the drive mechanism in the second direction may comprise rotation of the shaft in the second direction. The vertical blade mechanism may comprise a gear and a connecting rod coupled to the vertical blade set. The horizontal blade mechanism may comprise a cam and a follower coupled to the horizontal blade set. The cam may comprise a spiral cam.

The present invention relates to an air vent assembly configured for a vehicle interior comprising an inner blade set comprising a plurality of blades, an outer blade set comprising a plurality of blades and a drive mechanism comprising an inner blade mechanism configured to actuate the inner blade set and an outer blade mechanism configured to actuate the outer blade set. The drive mechanism may be configured to be operated in a first direction and a second direction. The drive mechanism may be configured so that (1) when operated in the first direction the inner blade mechanism is actuated and (2) when operated in the second direction the inner blade mechanism is actuated and the outer blade mechanism is actuated. The assembly may comprise a motor configured to operate the drive mechanism. The motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction. The inner blade mechanism may comprise a gear and a connecting rod coupled to the inner blade set. The inner blade mechanism may comprise a rack and pinion. The outer blade mechanism may comprise a cam and a follower coupled to the outer blade set. The cam may comprise a spiral cam. The drive mechanism may comprise a clutch assembly configured to engage the drive mechanism so that (1) when operated in the first direction only the inner blade mechanism is actuated and (2) when operated in the second direction both the inner blade mechanism is actuated and the outer blade mechanism is actuated. The inner blade set may comprise a vertical blade set comprising a plurality of generally vertical blades; the outer blade set may comprise a horizontal blade set comprising a plurality of generally horizontal blades.

The present invention relates to an air vent assembly configured for a vehicle interior comprising a vertical blade set comprising a plurality of generally vertical blades, a horizontal blade set comprising a plurality of generally horizontal blades and a drive mechanism comprising a vertical blade mechanism configured to actuate the vertical blade set and a horizontal blade mechanism configured to actuate the horizontal blade set. The drive mechanism may be configured to be operated in a first direction and a second direction. The drive mechanism may be configured so that (1) when operated in the first direction the vertical blade mechanism is actuated and (2) when operated in the second direction the vertical blade mechanism is actuated and the horizontal blade mechanism is actuated. The assembly may comprise a motor configured to operate the drive mechanism. The motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction. The vertical blade mechanism may comprise a gear and a connecting rod coupled to the vertical blade set. The vertical blade mechanism may comprise a rack and pinion. The horizontal blade mechanism may comprise a cam and a follower coupled to the horizontal blade set. The cam may comprise a spiral cam. The drive mechanism may comprise a clutch assembly configured to engage the drive mechanism so that (1) when operated in the first direction only the vertical blade mechanism is actuated and (2) when operated in the second direction both the vertical blade mechanism is actuated and the horizontal blade mechanism is actuated.

The present invention relates to an air vent system configured for a vehicle interior comprising a vertical blade set comprising a plurality of generally vertical blades, a horizontal blade set comprising a plurality of generally horizontal blades and a drive mechanism configured to be operated in a first direction and a second direction. The drive mechanism may comprise a vertical blade mechanism configured to actuate the vertical blade set. The drive mechanism may comprise a horizontal blade mechanism configured to actuate the horizontal blade set. The drive mechanism may comprise a clutch mechanism configured to engage the drive mechanism so that (1) when operated in the first direction only the vertical blade mechanism is actuated and (2) when operated in the second direction both the vertical blade mechanism is actuated and the horizontal blade mechanism is actuated. The clutch mechanism may comprise an inner ring and an outer ring. The inner airflow guide may be configured to direct airflow in a first airflow direction and the outer airflow guide may be configured to direct airflow in a second airflow direction. The inner airflow guide may be configured to direct airflow in a generally horizontal direction and the outer airflow guide may be configured to direct airflow in a generally vertical direction. The inner airflow guide may comprise an inner blade set comprising a plurality of vanes; the outer airflow guide may comprise an outer blade set comprising a plurality of vanes. The inner blade set may comprise a vertical blade set comprising a plurality of generally vertical vanes; the outer vanes set may comprise a horizontal blade set comprising a plurality of generally horizontal vanes.

The present invention relates to a vehicle interior component providing a passage for airflow and comprising a vertical guide configured to guide airflow, a horizontal guide configured to guide airflow, a motor configured to move the horizontal guide between a lower position and an upper position and to move the vertical guide between a left position and a right position, and a transmission mechanism coupled to the motor, the vertical guide and the horizontal guide. The transmission mechanism may be configured for simultaneous movement of the vertical guide and the horizontal guide and individual movement of one of the vertical guide and the horizontal guide with the other of the vertical guide and the horizontal guide in a fixed position. The motor may be configured to rotate in a first direction to provide simultaneous movement of the vertical guide and the horizontal guide. The motor may be configured to rotate in a second direction opposite to the first direction to provide individual movement of one of the vertical guide and the horizontal guide with the other of the vertical guide and the horizontal guide in a fixed position. The transmission mechanism may comprise a one-way bearing. The transmission mechanism may comprise an inner ring and an outer ring; the outer ring may be positioned substantially concentrically about the inner ring. The transmission mechanism may be configured for (a) simultaneous movement of the inner ring and the outer ring; and (b) individual movement of one of the inner ring and the outer ring with the other of the inner ring and the outer ring in a fixed position. The transmission mechanism may comprise a set of wedges and a cage. The vertical guide may comprise a set of vanes; the horizontal guide may comprise a set of vanes.

The present invention relates to a vehicle interior component providing a passage for airflow and comprising a vertical guide configured to guide airflow, a horizontal guide configured to guide airflow, and a motor comprising a shaft and configured to move the vertical guide between a left position and a right position and to move the horizontal guide between a lower position and an upper position. The motor may be configured to rotate in a first direction to provide simultaneous movement of the vertical guide and the horizontal guide. The motor may be configured to rotate in a second direction opposite to the first direction to provide individual movement of one of the vertical guide and the horizontal guide with the other of the vertical guide and the horizontal guide in a fixed position.

The present invention relates to an air outlet comprising a motor comprising an output shaft, a one-way bearing comprising an inner ring and an outer ring and an inner air guiding device and an outer air guiding device, the inner air guiding device may be coupled to the inner ring and the outer air guiding device may be coupled to the outer ring, or the inner air guiding device may be coupled to the outer ring and the outer air guiding device may be coupled to the inner ring. The output shaft may be coupled to either the inner ring or the outer ring. By means of forward and reverse rotation of the output shaft, the motor may drive the inner air guiding device and the outer air guiding device simultaneously through the one-way bearing and may drive the inner air guiding device or the outer air guiding device separately through the one-way bearing. The air outlet may comprise an inner air guiding device transmission mechanism and an outer air guiding device transmission mechanism, the inner air guiding device being coupled to the inner ring through the inner air guiding device transmission mechanism, and the outer air guiding device being coupled to the outer ring through the outer air guiding device transmission mechanism. The inner air guiding device transmission mechanism may comprise a connecting rod, one end of the connecting rod being coupled to the inner air guiding device, and the other end of the connecting rod being coupled to the inner ring. The inner air guiding device transmission mechanism may comprise a central shaft, the central shaft may be connected to the inner ring for synchronous rotation, or the central shaft and the inner ring are integrated into one part, and the other end of the connecting rod may be eccentrically connected to the central shaft. The output shaft may be coupled to the central shaft. The outer air guiding device transmission mechanism may comprise a transmission rod, one end of the transmission rod being coupled to the outer air guiding device, and the other end of the transmission rod being coupled to the outer ring. The transmission rod may be provided with a protrusion, and the outer air guiding device transmission mechanism may comprise a spiral cam provided with a spiral groove, the spiral cam may be connected to the outer ring for synchronous rotation, or the spiral cam and the outer ring are integrated into one part, and the protrusion may be fit for moving in the spiral groove. The output shaft may be coupled to the inner ring through a gear set. The inner air guiding device may comprise a blade, a roller or a moving block, and the outer air guiding device may comprise a blade, a roller or a moving block. The outer air guiding device may comprise a set of outer blades comprising two outer blades arranged in parallel, and each of the outer blades may comprise two blades hinged to each other.

### FIGURES

FIGS. 1A and 1B are schematic perspective views of a vehicle providing an interior according to an exemplary embodiment.

FIG. 1C is a schematic perspective view of a vehicle interior according to an exemplary embodiment.

FIG. 2 is a schematic diagram of an air vent system for a vehicle interior according to an exemplary embodiment.

FIGS. 3A to 3B are schematic perspective views of an air vent system for a vehicle interior according to an exemplary embodiment.

FIG. 4 is a schematic diagram of an air vent system for a vehicle interior according to an exemplary embodiment.

FIGS. 4A to 4B are schematic perspective views of an air vent system for a vehicle interior according to an exemplary embodiment.

FIG. 5 is a schematic diagram of an air vent system for a vehicle interior according to an exemplary embodiment.

FIGS. 5A to 5B are schematic perspective views of an air vent system for a vehicle interior according to an exemplary embodiment.

FIG. 6 is a schematic exploded perspective view of an air vent system for a vehicle interior according to an exemplary embodiment.

FIGS. 7A to 7B are schematic perspective views of an air vent system for a vehicle interior according to an exemplary embodiment.

FIGS. 8A to 8B are schematic perspective views of an air vent system for a vehicle interior according to an exemplary embodiment.

FIGS. 9A to 9B are schematic perspective views of an air vent system for a vehicle interior according to an exemplary embodiment.

FIGS. 10A to 10B are schematic partial perspective views of an air vent system for a vehicle interior according to an exemplary embodiment.

FIGS. 11A to 11B are schematic partial section views of an air vent system for a vehicle interior according to an exemplary embodiment.

FIGS. 12A to 12B are schematic perspective views of an air vent system for a vehicle interior according to an exemplary embodiment.

FIGS. 13A to 13B are schematic perspective views of an air vent system for a vehicle interior according to an exemplary embodiment.

FIGS. 14A to 14B are schematic perspective views of an air vent system for a vehicle interior according to an exemplary embodiment.

FIGS. 15A to 15B are schematic perspective views of an air vent system for a vehicle interior according to an exemplary embodiment.

FIG. 16 is a schematic diagram of an air vent system for a vehicle interior according to an exemplary embodiment.

FIGS. 16A to 16C are schematic perspective views of an air vent system for a vehicle interior according to an exemplary embodiment.

FIG. 17 is a schematic perspective view of an air vent system for a vehicle interior according to an exemplary embodiment.

FIG. 18 is a schematic partial perspective view of an air vent system for a vehicle interior according to an exemplary embodiment.

FIG. 19 is a schematic perspective view of an air vent system for a vehicle interior according to an exemplary embodiment.

FIG. 20 is a schematic exploded partial perspective view of an air vent system for a vehicle interior according to an exemplary embodiment.

FIG. 21 is a schematic exploded partial perspective view of an air vent system for a vehicle interior according to an exemplary embodiment.

FIG. 22 is a schematic partial section view of an air vent system for a vehicle interior according to an exemplary embodiment.

FIG. 23 is a schematic partial section view of an air vent system for a vehicle interior according to an exemplary embodiment.

FIG. 24 is a schematic partial section view of an air vent system for a vehicle interior according to an exemplary embodiment.

FIGS. 25A to 25B are schematic cutaway section views of an air vent system for a vehicle interior according to an exemplary embodiment.

FIGS. 26A to 26B are schematic perspective views of an air vent system for a vehicle interior according to an exemplary embodiment.

FIGS. 27A to 27F are tables indicating operation of the drive mechanism of the air vent system for a vehicle interior according to an exemplary embodiment.

### DESCRIPTION

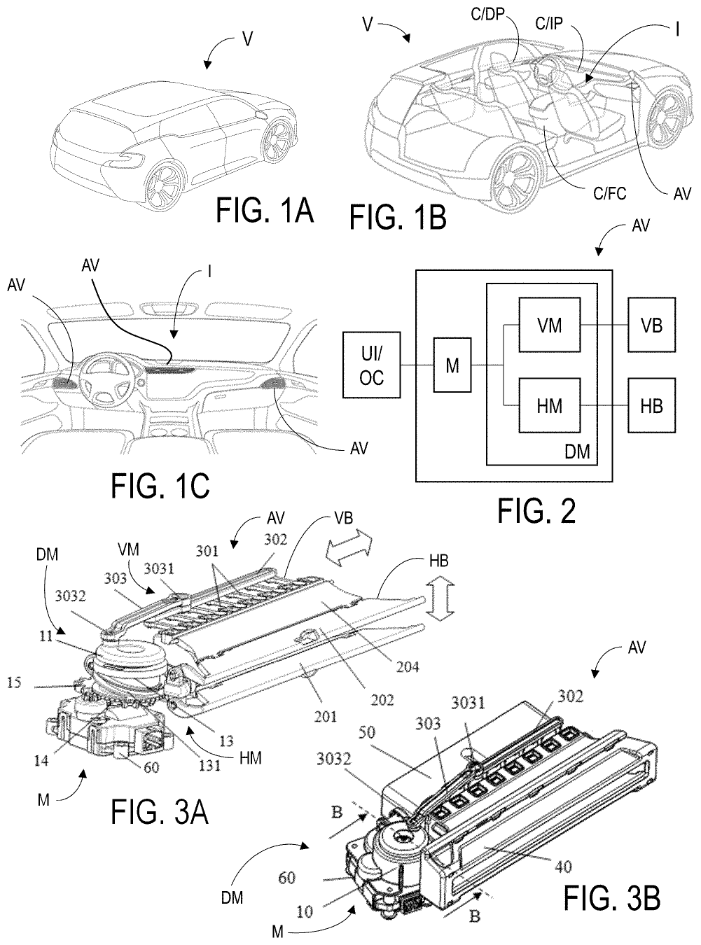

Referring to FIGS. 1A-1C, a vehicle V is shown according to an exemplary embodiment comprising an interior I providing components C such as an instrument panel IP, door panel DP, floor console FC, etc. As indicated in FIGS. 1B and 1C, one or more component of the vehicle interior may comprise an air vent assembly/system AV with an inlet/connection to airflow from the heating/cooling/ventilation system of the vehicle and providing an outlet for airflow into the vehicle interior.

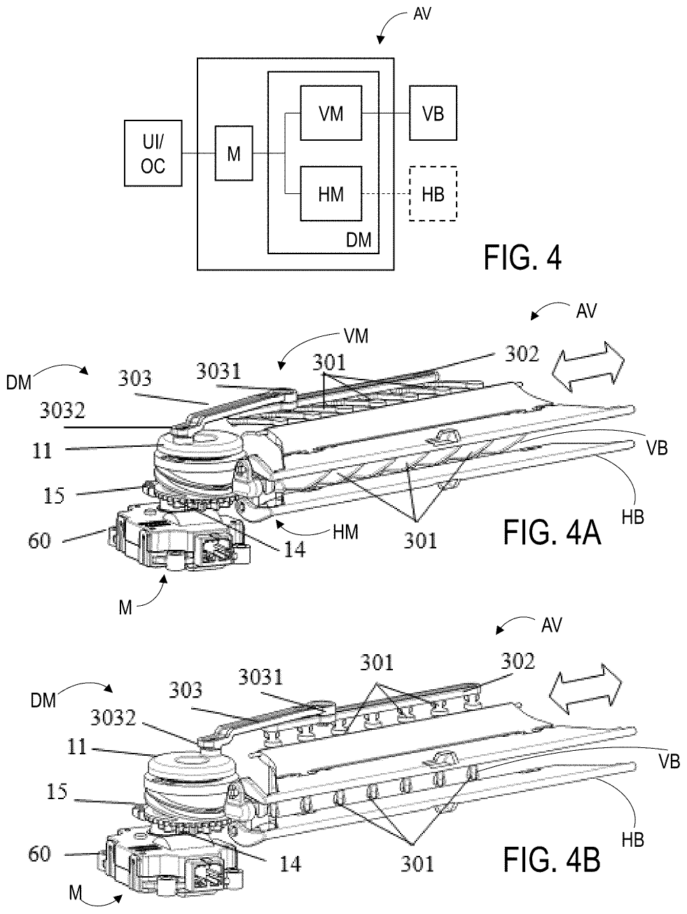

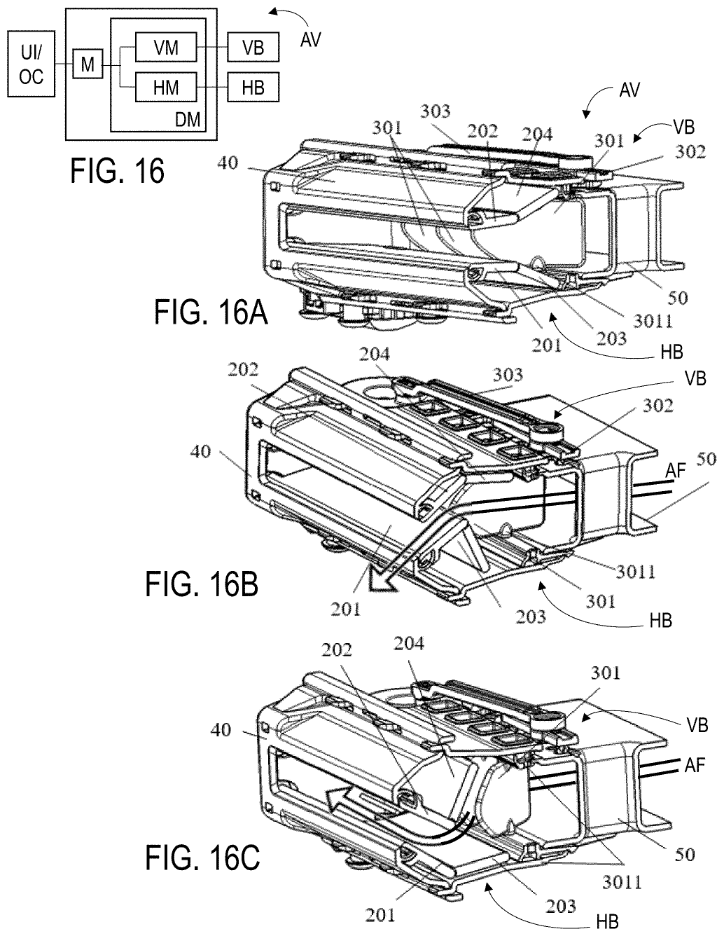

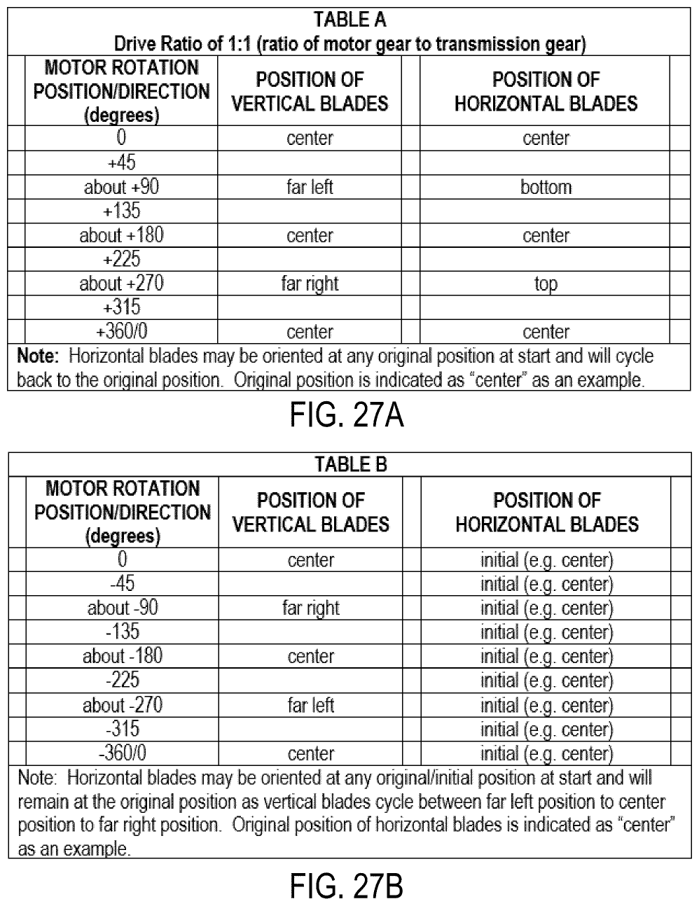

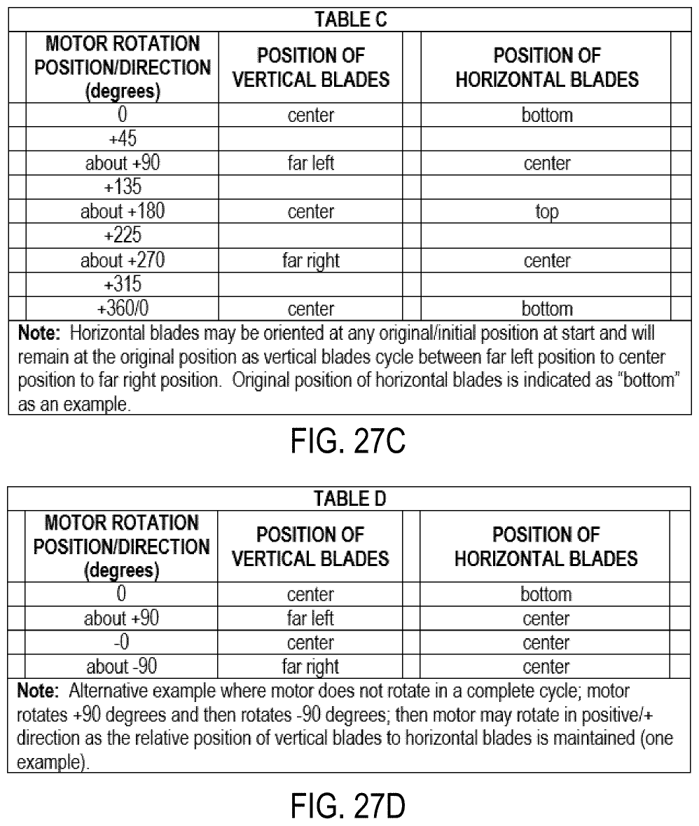

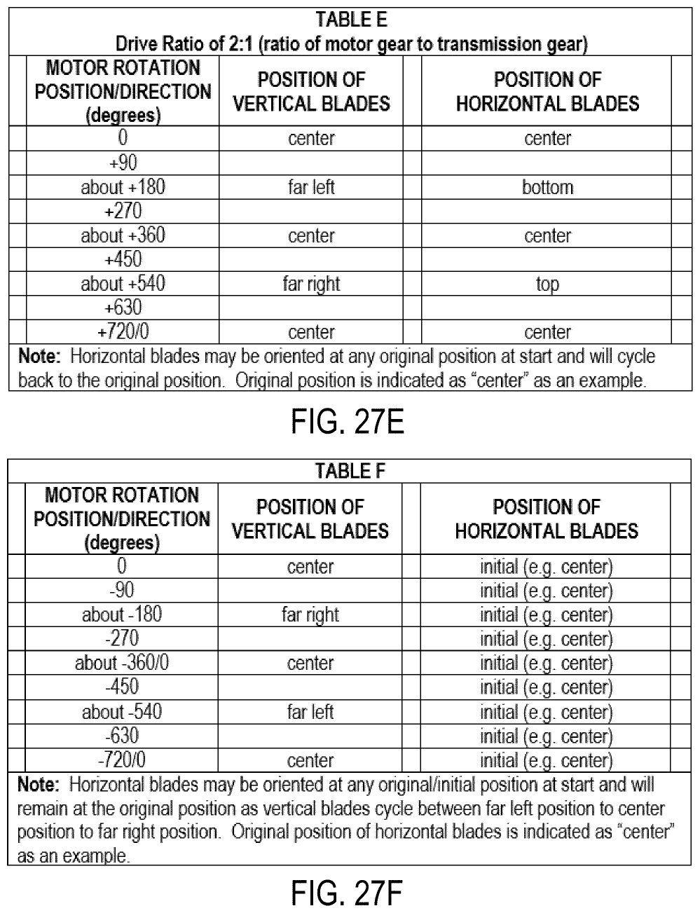

As shown schematically in FIGS. 2 and 3A-3B, air vent assembly/system AV provided for a vehicle interior (e.g. providing an outlet into the vehicle interior from an inlet from the vehicle heating/cooling/ventilation system) may comprise a user interface/operator control UI/OC and a drive mechanism DM operated by a motor M; the air vent system/assembly may comprise an inner airflow guide mechanism VM for an inner airflow guide shown as comprising inner/vertical blade set VB and an outer airflow guide mechanism HM for an outer airflow guide shown as comprising outer/horizontal blade set HB. See also FIGS. 4, 5 and 16. As indicated schematically in FIGS. 3A-3B, 4, 4A-4B, 5, 5A-5B and 6, drive mechanism DM of air vent assembly/system AV may comprise inner airflow mechanism VM configured to actuate inner airflow guide VB and outer airflow mechanism HM configured to actuate outer airflow guide HB. See also FIGS. 16, 16A-16C and 27A-27F.

As indicated schematically in FIGS. 3A-3B, 4, 4A-4B, 16, 16A-16C, 24, 25A-25B, 26A-26B, 27A-27C and 27E-27F, drive mechanism DM of air vent assembly/system AV may be configured to be operated in a first direction and a second direction; drive mechanism DM may be configured so that (1) when operated in the first direction inner/vertical airflow mechanism VM/VB is actuated (e.g. directed/moved to guide airflow AF to an outlet) and (2) when operated in the second direction both inner/vertical airflow mechanism VM/VB is actuated (e.g. directed/moved to guide airflow AF to an outlet) and outer/horizontal airflow mechanism HM/HB is actuated (e.g. directed/moved to guide airflow AF to an outlet). See also FIGS. 2, 5, 5A-5B and 27D (adjustment of relative positioning of inner airflow guides/vertical blades and outer airflow guides/horizontal blades).

As shown schematically in FIGS. 2, 3A-3B, 4, 4A-4B, 5, 5A-5B, 6, 24, 25A-25B, 26A-26B and 27A-27F, air vent assembly/system AV may comprise a motor M configured to operate drive mechanism DM; motor M may be configured to operate a shaft to operate drive mechanism DM; operation of drive mechanism DM in the first direction may comprise rotation of the shaft in the first direction and operation of drive mechanism DM in the second direction may comprise rotation of the shaft in the second direction. Compare FIGS. 4, 4A-4B, 27B and 27F (operation in first direction for actuation of inner airflow mechanism/guide VM) with FIGS. 3A-3B, 16, 16A-16C, 27A, 27C and 27E (operation in second direction for actuation of inner airflow mechanism/guide VM and outer airflow mechanism/guide HM).

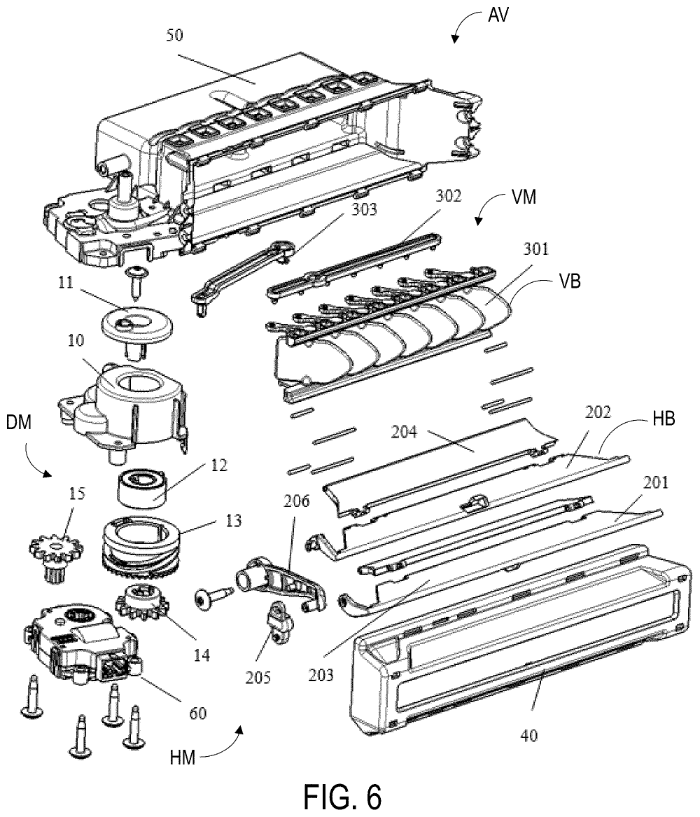

As shown schematically in FIGS. 3A-3B, 4, 4A-4B, 16, 16A-16C, 24, 25A-25B, 26A-26B and 27A-27F, drive mechanism DM may comprise a clutch assembly/mechanism CM configured to engage at drive mechanism DM so that (1) when operated in the first direction only inner airflow mechanism VM is actuated and (2) when operated in the second direction both inner airflow mechanism VM is actuated and outer airflow mechanism HM is actuated. See also FIG. 6. As indicated schematically in FIGS. 6, 24 and 25A-25B, clutch assembly CM may comprise an inner ring and an outer ring; clutch assembly CM may comprise a one-way bearing. As indicated schematically in FIGS. 3A-3B, 4A-4B, 5A-5B and 6, inner airflow mechanism VM may comprise a gear and a connecting rod coupled to inner airflow guide VB; inner airflow mechanism VM may comprise a rack and pinion; outer airflow mechanism HM may comprise a cam and a follower coupled to outer airflow guide HB; the cam may comprise a spiral cam. See also FIGS. 16, 16A-16C and 26A-26B.

As indicated schematically in FIGS. 3A-3B, 4A-4B, 5A-5B, 16A-16C and 26A-26C, inner airflow guide VB may be configured to direct airflow AF in a first airflow direction and outer airflow guide HB may be configured to direct airflow AF in a second airflow direction; the inner airflow guide may comprise an inner blade set VB comprising a plurality of blades; the outer airflow guide may comprise an outer blade set HB comprising a plurality of blades; the inner blade set may comprise a vertical blade set VB comprising a plurality of generally vertical blades; the outer blade set may comprise a horizontal blade set HB comprising a plurality of generally horizontal blades.

As indicated schematically FIGS. 2, 3A-3B and 27A-27F, operation of air vent system AV to direct airflow with drive mechanism DM with clutch arrangement CM by an operator control at a user interface UI in a first direction may actuate inner/vertical blade set mechanism VM/VB and in a second direction will actuate both inner/vertical blade set mechanism VM/VB and outer/horizontal blade set mechanism HM/HB. See also FIGS. 4, 4A-4B, 16, 16A-16C, 25A-25B and 26A-26B.

### Exemplary Embodiments—A

As shown schematically according to an exemplary embodiment in FIGS. 1A, 1B and 1C, a vehicle V may comprise an interior I having a components C such as an instrument panel/dashboard IP; an air vent assembly/system AV providing air outlets (from an inlet coupled to an vehicle heating/ventilation/cooling system) may be provided with components C (e.g. arranged in the center of and on both sides of the dashboard, on the rear side of a console, only in the center of the dashboard, arranged in any other position as needed, etc.).

As shown schematically in FIGS. 2, 3A-3B and 6, air vent assembly/system AV provided for a vehicle interior (e.g. providing an outlet into the vehicle interior from an inlet from the vehicle heating/cooling/ventilation system) may comprise a user interface/operator control UI/OC and a drive mechanism DM operated by a motor M; the air vent system/assembly may comprise an inner airflow guide mechanism VM for an inner airflow guide shown as comprising inner/vertical blade set VB and an outer airflow guide mechanism HM for an outer airflow guide shown as comprising outer/horizontal blade set HB. As indicated schematically in FIGS. 2, 3A-3B, 4A-4B and 5A-5B, drive mechanism DM may comprise inner airflow mechanism VM configured to actuate inner airflow guide VB and outer airflow mechanism HM configured to actuate outer airflow guide HB. See also FIGS. 16, 16A-16C and 27A-27F.

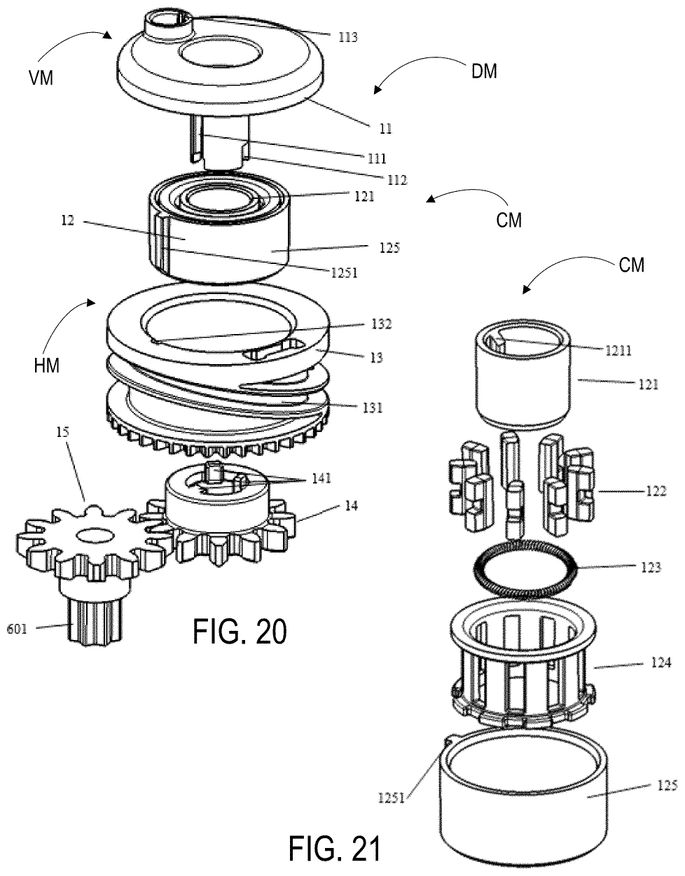

As indicated in FIGS. 6, 20, 21, 24 and 25A-25B, a clutch mechanism CM comprising a one-way bearing component 10 may be provided for drive mechanism DM (e.g. mounted on side/coupled to motor M/60); motor 60 may comprise an output shaft 601. As shown schematically in FIGS. 3A-3B and 6, air outlet AV may comprise inner blades and outer blades; the inner blades may be vertical blades, and the outer blades may be horizontal blades; the air outlet may comprise an inner blade transmission mechanism and an outer blade transmission mechanism; the air outlet may comprise a housing provided inside with the inner blades and the outer blades and may comprise a front cover 40 and a rear cover 50. As shown schematically in FIGS. 20 and 21, a one-way bearing 12 may comprise an inner ring 121 and an outer ring 125; inner ring 121 and a central shaft 11 may be fitted together through an inner shaft key 1211 and a key groove 111 for synchronous rotation; outer ring 125 and a spiral cam 13 may be fitted together through a key 1251 and a key groove 132 for synchronous rotation; an output shaft 601 and a motor output gear 15 are integrated into one part, which is engaged with a transmission gear 14 through motor output gear 15, and transmission gear 14 may be connected to central shaft 11, so that the motor may drive inner ring 121. As indicated schematically in FIG. 6, the vertical blades are connected to central shaft 11 through a connecting rod and are driven by the rotation of inner ring 121, and the horizontal blades are connected to spiral cam 13 through a connecting rod and are driven by the rotation of outer ring 125; by means of forward and reverse rotation of output shaft 601, motor 60 either drives the vertical blades and the horizontal blades simultaneously through one-way bearing component 10 or drives the vertical blades alone through one-way bearing component 10. See also FIGS. 2, 3A-3B, 4, 4A-4B, 5, 5A-5B, 6, 24, 25A-25B, 26A-26B and 27A-27F. As indicated schematically in FIGS. 2, 3A-3B, 4, 4A-4B, 5, 5A-5B, 6, 24, 25A-25B, 26A-26B and 27A-27F, motor 60 may drive the vertical blades alone for reciprocating rotation, the vertical blades and the horizontal blades may be driven for simultaneous rotation, the angle between the vertical blades and the horizontal blades may be adjusted, and the horizontal blades or the vertical blades may be positioned at will. According to an exemplary embodiment, motor output gear 15 may drive spiral cam 13 instead of central shaft 11; the horizontal blades may be controlled alone for reciprocating rotation in a vertical direction; and the horizontal blades and the vertical blades may be controlled for simultaneous rotation.

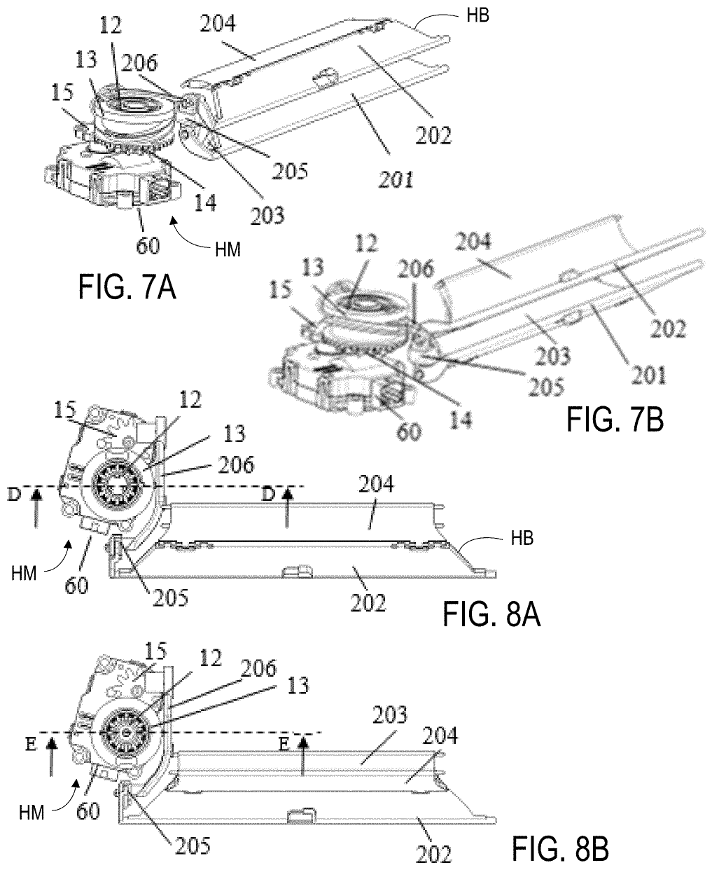

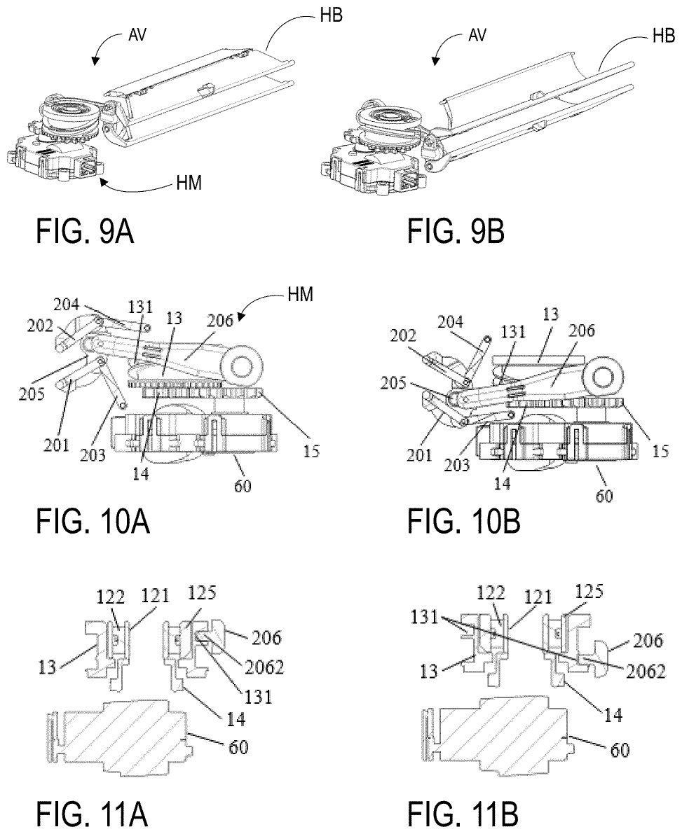

According to an exemplary embodiment as shown schematically in FIGS. 3A-3C, 6, 16A to 16C, the horizontal blades may comprise two layers of horizontal blades arranged in parallel, and each layer of horizontal blade may comprise two blades hinged to each other; lower horizontal blades may comprise a first horizontal lower blade 201 and a second horizontal lower blade 203; upper horizontal blades may comprise a first horizontal upper blade 202 and a second horizontal upper blade 204; by rotation of first horizontal lower blade 201 and first horizontal upper blade 202, second horizontal lower blade 203 and second horizontal upper blade 204 may be driven for movement so as to control the air blowing angle in the vertical direction, while the air blowing angle in the horizontal direction is changed by the rotation of a plurality of vertical blades 301 around their respective rotating shafts; the horizontal blades may have the structure of a blade set. See also FIGS. 4A-4B, 5A-5B, 7A-7B, 8A-8B, 9A-9B, 10A-10B and 11A-11B.

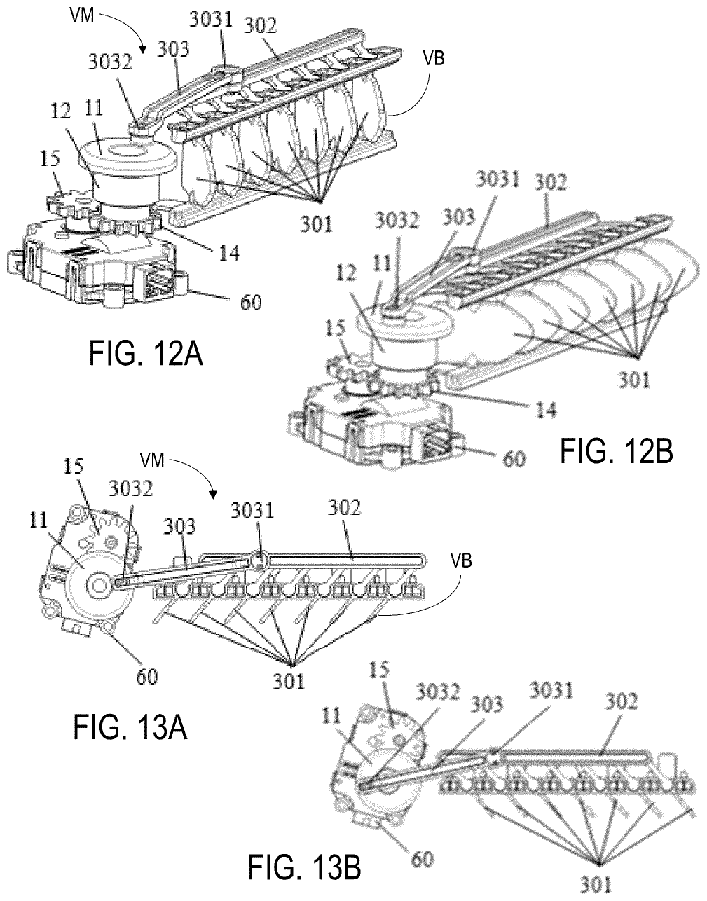

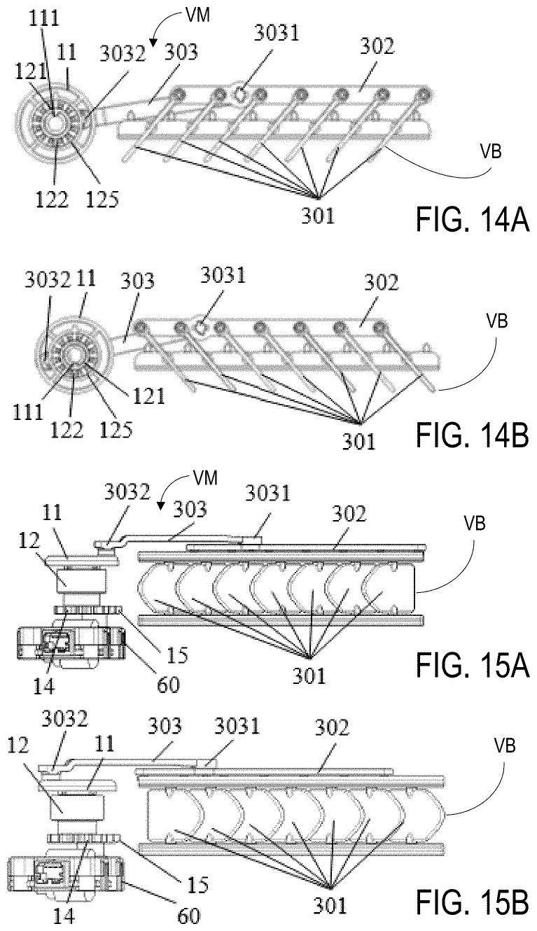

According to an exemplary embodiment as shown schematically in FIGS. 3B, 6 and 19, the air outlet may couple vertical blades 301 and one-way bearing component 10 (or more specifically, inner ring 121 of one-way bearing 12) together through the inner blade transmission mechanism; the inner blade transmission mechanism may comprise an inner blade connecting rod 302 connected to a rotating shaft 3011 of vertical blades 301; the inner blade transmission mechanism may comprise a connecting rod 303, one end of connecting rod 303 may be provided with a first connecting rod rotating shaft 3031, the other end of the connecting rod may be provided with a second connecting rod rotating shaft 3032, connecting rod 303 may be connected to inner blade connecting rod 302 through first connecting rod rotating shaft 3031 and connected to central shaft 11 through second connecting rod rotating shaft 3032, and the drive connection with inner ring 121 may be achieved through central shaft 11; a four-connecting rod reciprocating mechanism may be formed (e.g. a plurality of vertical blades 301 may rotate from side to side around their respective rotating shafts 3011 at a fixed angle for one cycle by rotation of inner ring 121 of one-way bearing 10 around the central shaft for one circle). See also FIGS. 4A-4B, 12A-12B, 13A-13B, 14A-14B and 15A-15B. According to an exemplary embodiment as shown schematically in FIGS. 4A, 12B, and 14B, when the inner blade driving component of the air outlet blows rightward, motor output gear 15 drives central shaft 11 to rotate through transmission gear 14, so as to drive second connecting rod rotating shaft 3032 of connecting rod 303 to rotate to the left, and inner blade connecting rod 302 may be pulled to the left, driving inner blades 301 to deflect to the right. According to an exemplary embodiment as shown schematically in FIGS. 4B, 12A, and 14A, when the inner blade driving component of the air outlet blows leftward, motor output gear 15 drives central shaft 11 to rotate through transmission gear 14, so as to drive second connecting rod rotating shaft 3032 of connecting rod 303 to rotate to the right, and inner blade connecting rod 302 may be pulled to the right, driving inner blades 301 to deflect to the left.

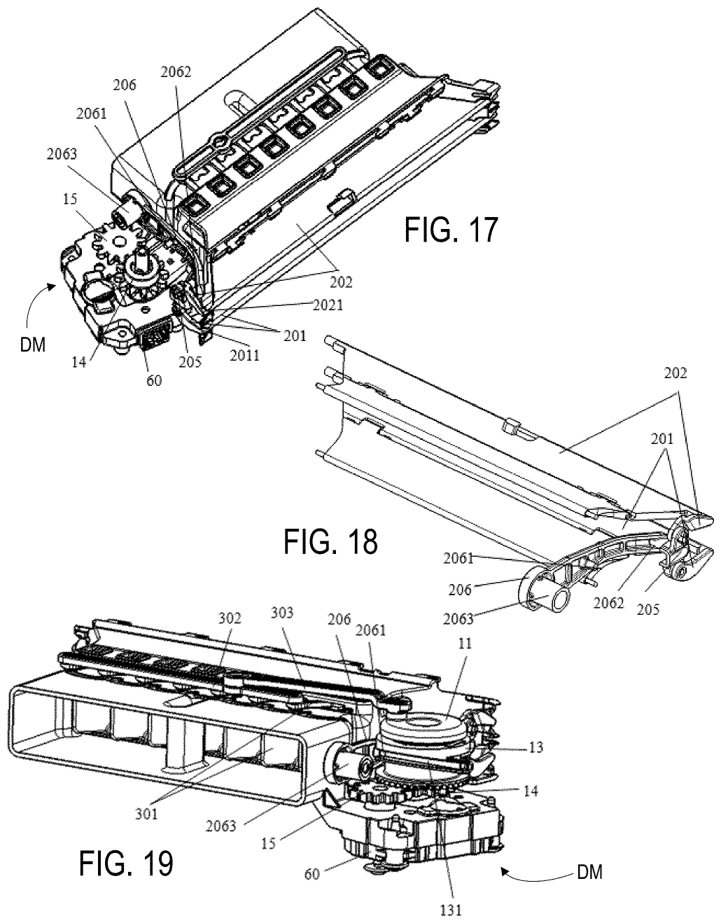

According to an exemplary embodiment as shown schematically in FIGS. 17 and 18, the air outlet may couple the horizontal blades and one-way bearing component 10 (i.e. outer ring 125 of one-way bearing 12) together through the outer blade transmission mechanism. According to an exemplary embodiment shown schematically in FIG. 6, the outer blade transmission mechanism may comprise an outer blade connecting rod 205 coupled to the horizontal blades; the outer blade transmission mechanism may comprise a transmission rod 206, one end of transmission rod 206 being coupled to outer blade connecting rod 205; the other end of transmission rod 206 being coupled to outer ring 125; transmission rod 206 may be provided with a transmission rod rotating shaft 2063; transmission rod 206 may be provided with a protrusion 2061, and the outer blade transmission mechanism may comprise a spiral cam 13 provided with a spiral groove 131, protrusion 2061 is fit for moving in spiral groove 131, spiral cam 13 is fitted with outer ring 125 for synchronous rotation, and transmission rod 206 is driven to rotate around transmission rod rotating shaft 2063 in a reciprocating manner; when spiral cam 13 rotates around the central shaft of one-way bearing 12, the air outlet fixes first horizontal lower blade 201 and first horizontal upper blade 202 together through outer blade connecting rod 205, so that first horizontal lower blade 201 and first horizontal upper blade 202 may rotate around their respective rotating shafts 2011 and 2021; first horizontal lower blade 201 and first horizontal upper blade 202 are parallel or maintain a specific range of angle change; first horizontal lower blade 201 and first horizontal upper blade 202 may be driven to rotate as long as outer blade connecting rod 205 is driven to move up and down vertically; a shaft pin 2062 of transmission rod 206 is fitted on outer blade connecting rod 205; when transmission rod 206 rotates around transmission rod rotating shaft 2063, outer blade connecting rod 205 may be driven to move in the vertical direction, thereby driving first horizontal lower blade 201 and first horizontal upper blade 202 to rotate. According to an exemplary embodiment indicated in FIG. 27A, the rotation of spiral groove 131 of spiral cam 13 around the central shaft for one circle corresponds to one cycle of transmission rod 206 rotating up and down around transmission rod rotating shaft 2063 at a fixed angle, and one cycle of the horizontal blades rotating up and down. According to an exemplary embodiment, the drive mechanism provided for transmission between the horizontal blades and the one-way bearing component and between the vertical blades and the one-way bearing component in the air outlet; the four-connecting rod reciprocating mechanism and the reciprocating mechanism of the spiral cam and the transmission rod provide driving components for followers to reciprocate by rotating around their own central shaft. See FIGS. 2, 3A-3B, 4, 4A-4B, 5, 5A-5B, 6, 24, 25A-25B, 26A-26B and 27A-27F.

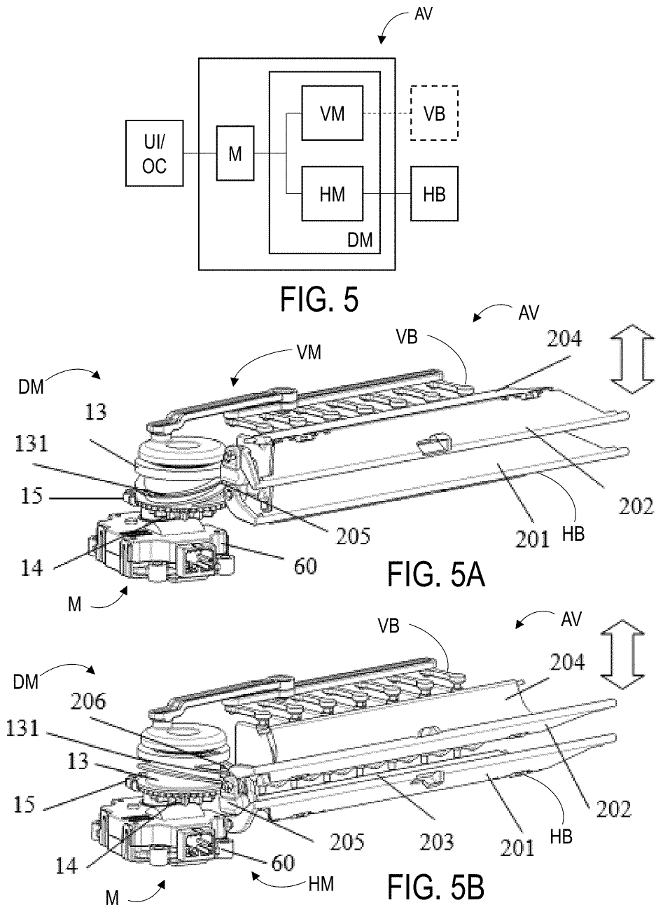

According to an exemplary embodiment as shown schematically in FIGS. 5A, 7A and 10A, when the inner blade driving component of the air outlet/airflow blows downward, central shaft 11 may drive one-way bearing 12 and spiral cam 13 to rotate, so that the left side of spiral groove 131 rotates to the lowest point, and the right side rotates to the highest point, and transmission rod 206 may swing upward to the highest point, and transmission rod 206 may drive outer blade connecting rod 205 to move to the highest point, so as to drive first horizontal lower blade 201 and first horizontal upper blade 202 to deflect downward.

According to an exemplary embodiment as shown schematically in FIGS. 5B, 7B and 10B, when the inner blade driving component of the air outlet/airflow blows upward, central shaft 11 may drive one-way bearing 12 and spiral cam 13 to rotate, so that the left side of spiral groove 131 rotates to the highest point, and the right side rotates to the lowest point, and transmission rod 206 may swing downward to the lowest point, and transmission rod 206 may drive outer blade connecting rod 205 to move to the lowest point, so as to drive first horizontal lower blade 201 and first horizontal upper blade 202 to deflect upward. As shown schematically, one-way bearing component 10 may be coupled to the horizontal blades and the vertical blades through the inner blade transmission mechanism and the outer blade transmission mechanism, so as to realize a rotation input (i.e., a forward and backward rotation of a motor to drive two sets of functional/movement components).

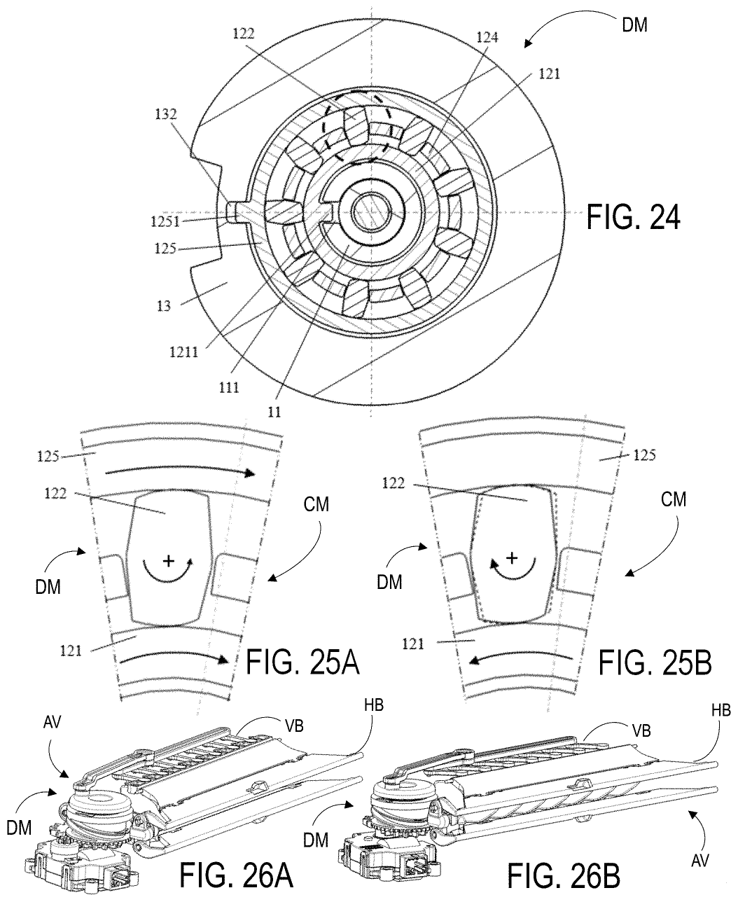

According to an exemplary embodiment as shown schematically in FIG. 20, one-way bearing component 10 may be provided with central shaft 11, one-way bearing 12, spiral cam 13, central shaft driving gear 14 and motor output gear 15 mounted on output shaft 601. Motor output gear 15 may not be provided, and central shaft driving gear 14 may be directly used as the output power part of the motor, depending on the transmission performance requirements of the component; one-way bearing 12 may be a modified version of wedge-type one-way bearing (e.g. FE/element). See also FIGS. 24 and 25A-25B. According to an exemplary embodiment, the clutch mechanism/assembly may comprise other types of elements, mechanisms, bearings, one-way bearings, etc. configured to provide transmission (e.g. stepless transmission, etc.). According to an exemplary embodiment as shown schematically in FIG. 20, one-way bearing 12 may comprise inner ring 121, brake wedges 122, a spring coil 123, a cage 124, and outer ring 125; brake wedges 122 are circumferentially arranged between inner ring 121 and outer ring 125 through cage 124; when central shaft 11 rotates counterclockwise, brake wedges 122 slip and do not rotate; when central shaft 11 rotates clockwise, brake wedges 122 are engaged to lock the relative movement of inner ring 121 to outer ring 125, thereby driving spiral cam 13 to rotate clockwise. See also FIGS. 24 and 25A-25B. According to an exemplary embodiment, central shaft 11 may comprise a through-hole 113 fitted with connecting rod 303, connecting rod 303 may be eccentrically connected to through-hole 113 of central shaft 11 through second connecting rod rotating shaft 3032, so as to ensure that connecting rod 303 may rotate around through-hole 113 without being separated from central shaft 11; central shaft 11 may comprise key groove 111 and a key groove 112, key groove 111 is matched with inner shaft key 1211 on inner ring 121 to connect the central shaft and the inner ring, ensuring synchronous rotation of inner ring 121 and central shaft 11; central shaft 11 and inner ring 121 may also be integrated into one part, and key groove 112 is matched with a key 141 on central shaft driving gear 14, ensuring synchronous rotation of central shaft 11 and central shaft driving gear 14. See also FIG. 6. According to an exemplary embodiment, spiral cam 13 may be similar to a circular column; the outer cylindrical surface may be designed with spiral groove 131 matched with protrusion 2061 on transmission rod 206, so that the rotation of spiral cam 13 may drive transmission rod 206 to rotate up and down in a reciprocating manner; the inner cylindrical ring may be designed with key groove 132 matched with shaft key 1251 on outer ring 125, so that the synchronous rotation of spiral cam 13 and outer ring 125 is ensured, and spiral cam 13 and outer ring 125 may also be integrated into one part. According to an exemplary embodiment indicated in FIG. 6, central shaft driving gear 14 may be engaged with motor output gear 15, which may transmit the motor power output by output shaft 601 to one-way bearing 12. According to an exemplary embodiment, the output shaft may be directly coupled to the central shaft (e.g. where the motor output gear is not provided).

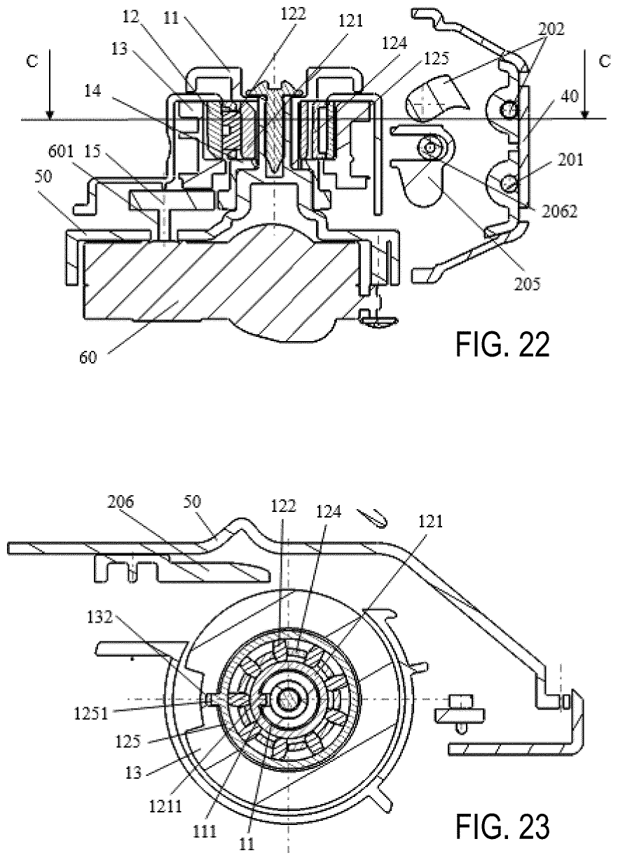

According to an exemplary embodiment as shown schematically in FIG. 22, motor 60 outputs power through motor output gear 15 mounted on output shaft 601; power may be transmitted to central shaft 11 through central shaft driving gear 14; the rotation of central shaft 11 may drive vertical blades 301; motor 60 may drive vertical blades 301 to rotate in a reciprocating manner by means of forward rotation and backward rotation. See also FIGS. 23, 24, 25A-25B, 26A-26B and 27A-27F. As indicated schematically, rotary power transmitted to central shaft 11 by the motor may also be transmitted to spiral cam 13 through wedge-type one-way bearing 12, so that the horizontal blades may be driven to rotate in a reciprocating manner through spiral cam 13; the wedge-type one-way bearing operates so that the power may only be transmitted by unidirectional rotation. See FIGS. 24 and 25A-25B. According to an exemplary embodiment as shown schematically in FIGS. 23 and 25A-25B, when central shaft 11 rotates clockwise around the central shaft with synchronous rotation of the wedge-type one-way bearing; brake wedges 122 may be driven, and then outer ring 125 and spiral cam 13 may be driven to rotate; when central shaft 11 rotates counterclockwise around the central shaft with idle rotation of the wedge-type one-way bearing; the brake wedges and spiral cam 13 cannot be driven to rotate together; when central shaft 11 is driven to rotate clockwise by motor 60, the motor may simultaneously control the horizontal blades and the vertical blades to synchronously rotate in a reciprocating manner, and when central shaft 11 is driven to rotate counterclockwise by motor 60; the motor may only control the vertical blades to rotate in a reciprocating manner (e.g. when the horizontal blades and the vertical blades need to be adjusted to satisfactory positions respectively, or when the travel angle position relationship between them needs to be adjusted, what needs to be done is just to simultaneously adjust the angles of the vertical blades and the horizontal blades first, allow the motor to rotate reversely once the angle of the horizontal blades is adjusted to a satisfactory position, and then adjust the angle of the vertical blades alone to a satisfactory position, so that both the horizontal blades and the vertical blades reach the satisfactory positions, and if the horizontal blades and the vertical blades are required to automatically sweep air in such a mutual position relationship, the motor is required to be rotated forward for driving the blades). See FIGS. 4, 4A-4B, 5, 5A-5B and 27A-27F (indicating modes of operation and of adjustment of relative positioning of inner airflow guides/vertical blades and outer airflow guides/horizontal blades). According to an exemplary embodiment indicated schematically in FIGS. 2, 3A-3B, 4, 4A-4B, 5, 5A-5B, 6, 24, 25A-25B, 26A-26B and 27A-27F, a single motor may drive and control the horizontal blades alone and may drive the horizontal blades and the vertical blades simultaneously; rotary power of the motor may be output to the spiral cam directly or through the gear, and then may be unidirectionally transmitted by the spiral cam to the inner ring through the one-way bearing.

According to an exemplary embodiment, the inner air guiding device and the outer air guiding device may comprise horizontal blades/vertical blades or may be in other forms/configurations such as a moving block or a roller and/or combinations (e.g. inner/outer air guiding devices may comprise blades, vanes, blocks, rollers, various combinations of vanes/blades with a roller, moving blocks, etc.).

### Exemplary Embodiments—B

According to an exemplary embodiment as shown schematically in FIGS. 2, 3A-3B, 4, 4A-4B, 5A-5B, 16, 16A-16C, 24, 25A-25B, 26A-26B AND 27A-27F, an air vent assembly configured for a vehicle interior may comprise an inner airflow guide, an outer airflow guide and a drive mechanism comprising an inner airflow mechanism configured to actuate the inner airflow guide and an outer airflow mechanism configured to actuate the outer airflow guide; the drive mechanism may be configured to be operated in a first direction and a second direction; the drive mechanism may be configured so that (1) when operated in the first direction the inner airflow mechanism is actuated (and (2) when operated in the second direction the inner airflow mechanism is actuated and the outer airflow mechanism is actuated; the assembly may comprise a motor configured to operate the drive mechanism; the motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction; the drive mechanism may comprise a clutch assembly configured to engage at the drive mechanism so that (1) when operated in the first direction only the inner airflow mechanism is actuated and (2) when operated in the second direction both the inner airflow mechanism is actuated and the outer airflow mechanism is actuated; the clutch assembly may comprise an inner ring and an outer ring; the clutch assembly may comprise a one-way bearing; the inner airflow mechanism may comprise a gear and a connecting rod coupled to the inner airflow guide; the inner airflow mechanism may comprise a rack and pinion; the outer airflow mechanism may comprise a cam and a follower coupled to the outer airflow guide; the cam may comprise a spiral cam; the inner airflow guide may be configured to direct airflow in a first airflow direction and the outer airflow guide may be configured to direct airflow in a second airflow direction; the inner airflow guide may comprise an inner blade set comprising a plurality of blades; the outer airflow guide may comprise an outer blade set comprising a plurality of blades; the inner blade set may comprise a vertical blade set comprising a plurality of generally vertical blades; the outer blade set may comprise a horizontal blade set comprising a plurality of generally horizontal blades.

According to an exemplary embodiment as shown schematically in FIGS. 2, 3A-3B, 4, 4A-4B, 5A-5B, 16, 16A-16C, 24, 25A-25B, 26A-26B AND 27A-27F, an air vent system configured for a vehicle interior may comprise an inner blade set comprising a plurality of blades, an outer blade set comprising a plurality of blades, a drive mechanism configured to be operated in a first direction and a second direction and a motor configured to operate the drive mechanism; the drive mechanism may comprise an inner blade mechanism configured to actuate the inner blade set; the drive mechanism may comprise an outer blade mechanism configured to actuate the outer blade set. The drive mechanism may comprise a clutch mechanism configured to engage the drive mechanism so that (1) when operated in the first direction only the inner blade mechanism is actuated and (2) when operated in the second direction both the inner blade mechanism is actuated and the outer blade mechanism is actuated; the clutch mechanism may comprise an inner ring and an outer ring; the clutch mechanism may be configured so that both the inner ring and the outer ring are engaged when the drive mechanism is operated in the second direction.

According to an exemplary embodiment as shown schematically in FIGS. 2, 3A-3B, 4, 4A-4B, 5A-5B, 16, 16A-16C, 24, 25A-25B, 26A-26B AND 27A-27F, an air vent assembly configured for a vehicle interior may comprise a vertical blade set comprising a plurality of generally vertical blades, a horizontal blade set comprising a plurality of generally horizontal blades and a drive mechanism configured to be operated in a first direction and a second direction; the drive mechanism may comprise a vertical blade mechanism configured to actuate the vertical blade set; the drive mechanism may comprise a horizontal blade mechanism configured to actuate the horizontal blade set. The drive mechanism may comprise a clutch assembly configured to engage the drive mechanism so that (1) when operated in the first direction the vertical blade mechanism is actuated and (2) when operated in the second direction the vertical blade mechanism is actuated and the horizontal blade mechanism is actuated; the clutch assembly may be configured so that the drive mechanism is operated in the first direction to actuate only the vertical blade mechanism; the clutch assembly may be configured so that the drive mechanism is operated in the second direction both to actuate the vertical blade mechanism and to actuate the horizontal blade mechanism; the clutch assembly may be configured so that the drive mechanism is operated in the second direction to actuate the vertical blade mechanism and to actuate the horizontal blade mechanism synchronously with a one-to-one drive ratio. The assembly may comprise a motor configured to operate the drive mechanism; the motor may be configured to operate a shaft to operate the drive mechanism; operation of the drive mechanism in the first direction may comprise rotation of the shaft in the first direction and operation of the drive mechanism in the second direction may comprise rotation of the shaft in the second direction; the vertical blade mechanism may comprise a gear and a connecting rod coupled to the vertical blade set; the horizontal blade mechanism may comprise a cam and a follower coupled to the horizontal blade set; the cam may comprise a spiral cam.

According to an exemplary embodiment as shown schematically in FIGS. 2, 3A-3B, 4, 4A-4B, 5A-5B, 16, 16A-16C, 24, 25A-25B, 26A-26B AND 27A-27F, an air vent assembly configured for a vehicle interior may comprise an inner blade set comprising a plurality of blades, an outer blade set comprising a plurality of blades and a drive mechanism comprising an inner blade mechanism configured to actuate the inner blade set and an outer blade mechanism configured to actuate the outer blade set; the drive mechanism may be configured to be operated in a first direction and a second direction; the drive mechanism may be configured so that (1) when operated in the first direction the inner blade mechanism is actuated and (2) when operated in the second direction the inner blade mechanism is actuated and the outer blade mechanism is actuated; the assembly may comprise a motor configured to operate the drive mechanism; the motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction; the inner blade mechanism may comprise a gear and a connecting rod coupled to the inner blade set; the inner blade mechanism may comprise a rack and pinion; the outer blade mechanism may comprise a cam and a follower coupled to the outer blade set; the cam may comprise a spiral cam; the drive mechanism may comprise a clutch assembly configured to engage the drive mechanism so that (1) when operated in the first direction only the inner blade mechanism is actuated and (2) when operated in the second direction both the inner blade mechanism is actuated and the outer blade mechanism is actuated; the inner blade set may comprise a vertical blade set comprising a plurality of generally vertical blades; the outer blade set may comprise a horizontal blade set comprising a plurality of generally horizontal blades.

According to an exemplary embodiment as shown schematically in FIGS. 2, 3A-3B, 4, 4A-4B, 5A-5B, 16, 16A-16C, 24, 25A-25B, 26A-26B AND 27A-27F, an air vent assembly configured for a vehicle interior may comprise a vertical blade set comprising a plurality of generally vertical blades, a horizontal blade set comprising a plurality of generally horizontal blades and a drive mechanism comprising a vertical blade mechanism configured to actuate the vertical blade set and a horizontal blade mechanism configured to actuate the horizontal blade set; the drive mechanism may be configured to be operated in a first direction and a second direction; the drive mechanism may be configured so that (1) when operated in the first direction the vertical blade mechanism is actuated and (2) when operated in the second direction the vertical blade mechanism is actuated and the horizontal blade mechanism is actuated; the assembly may comprise a motor configured to operate the drive mechanism; the motor may be configured to operate a shaft to operate the drive mechanism. Operation of the drive mechanism in the first direction may comprise rotation of the shaft in the first direction and operation of the drive mechanism in the second direction may comprise rotation of the shaft in the second direction; the vertical blade mechanism may comprise a gear and a connecting rod coupled to the vertical blade set; the vertical blade mechanism may comprise a rack and pinion; the horizontal blade mechanism may comprise a cam and a follower coupled to the horizontal blade set; the cam may comprise a spiral cam; the drive mechanism may comprise a clutch assembly configured to engage the drive mechanism so that (1) when operated in the first direction only the vertical blade mechanism is actuated and (2) when operated in the second direction both the vertical blade mechanism is actuated and the horizontal blade mechanism is actuated.

According to an exemplary embodiment as shown schematically in FIGS. 2, 3A-3B, 4, 4A-4B, 5A-5B, 16, 16A-16C, 24, 25A-25B, 26A-26B and 27A-27F, an air vent system configured for a vehicle interior may comprise a vertical blade set comprising a plurality of generally vertical blades, a horizontal blade set comprising a plurality of generally horizontal blades and a drive mechanism configured to be operated in a first direction and a second direction; the drive mechanism may comprise a vertical blade mechanism configured to actuate the vertical blade set; the drive mechanism may comprise a horizontal blade mechanism configured to actuate the horizontal blade set. The drive mechanism may comprise a clutch mechanism configured to engage the drive mechanism so that (1) when operated in the first direction only the vertical blade mechanism is actuated and (2) when operated in the second direction both the vertical blade mechanism is actuated and the horizontal blade mechanism is actuated; the clutch mechanism may comprise an inner ring and an outer ring; the inner airflow guide may be configured to direct airflow in a first airflow direction and the outer airflow guide may be configured to direct airflow in a second airflow direction; the inner airflow guide may be configured to direct airflow in a generally horizontal direction and the outer airflow guide may be configured to direct airflow in a generally vertical direction; the inner airflow guide may comprise an inner blade set comprising a plurality of vanes; the outer airflow guide may comprise an outer blade set comprising a plurality of vanes; the inner blade set may comprise a vertical blade set comprising a plurality of generally vertical vanes; the outer vanes set may comprise a horizontal blade set comprising a plurality of generally horizontal vanes.

### Exemplary Embodiments—C

According to an exemplary embodiment as shown schematically in FIGS. 2, 3A-3B, 4, 4A-4B, 5A-5B, 16, 16A-16C, 24, 25A-25B, 26A-26B and 27A-27F, air vent systems providing air outlets for the interior of a vehicles may comprise airflow guides such as two sets of vanes/blades (e.g. horizontal blade set and vertical blade set) for controlling the airflow from the ventilation system of the vehicle (at an inlet) to an air outlet into the vehicle interior. In a conventional arrangement, manual control of airflow/guides may be realized through the transmission structure within the air outlet; electric-motor operated air outlets may comprise two motors (e.g. designed for separate control of two rows of blades).

According to an exemplary embodiment as shown schematically in FIGS. 2, 3A-3B, 4, 4A-4B, 5A-5B, 16, 16A-16C, 24, 25A-25B, 26A-26B and 27A-27F, an improved air vent system providing an air outlet for vehicle interior trim may comprise airflow guides shown as two sets of blades (e.g. vertical blade set and horizontal blade set) for airflow from an inlet to the air outlet driven; as indicated schematically, the airflow guides may be operated by a drive mechanism with a single motor (e.g. configured to operate one set of blades separately or both sets blades simultaneously/synchronously).

According to an exemplary embodiment as shown schematically in FIGS. 2, 3A-3B, 4, 4A-4B, 5A-5B, 16, 16A-16C, 24, 25A-25B, 26A-26B and 27A-27F, an air outlet may comprise: a motor comprising an output shaft; a one-way bearing comprising an inner ring and an outer ring, the output shaft being coupled to either the inner ring or the outer ring; and an inner air guiding device and an outer air guiding device, the inner air guiding device being coupled to the inner ring and the outer air guiding device being coupled to the outer ring, or the inner air guiding device being coupled to the outer ring and the outer air guiding device being coupled to the inner ring; by means of forward and reverse rotation of the output shaft, the motor drives the inner air guiding device and the outer air guiding device simultaneously through the one-way bearing and drives the inner air guiding device or the outer air guiding device separately through the one-way bearing (e.g. one-way bearing free to rotate in one direction and locked in the other direction, also referred to as overrunning clutch); the output shaft may be connected directly or indirectly to either the inner ring or the outer ring; the inner air guiding device is an air guiding device that is close to an inner side of the air outlet, and the outer air guiding device is an air guiding device that is close to an outer side of the air outlet; the outer air guiding device is closer to the space in the vehicle than the inner air guiding device; one of the inner and outer air guiding devices may vertically control the direction of airflow and the other may horizontally control the direction of airflow.

According to an exemplary embodiment as shown schematically in the FIGS. 2, 3A-3B, 4, 4A-4B, 5A-5B, 16, 16A-16C, 24, 25A-25B, 26A-26B and 27A-27F, the inner air guiding device may be an inner blade (e.g. a vertical blade, to horizontally control the direction of airflow; the outer air guiding device may be an outer blade and a horizontal blade to vertically control the direction of airflow; the inner air guiding device may be a horizontal blade and the outer air guiding device may be a vertical blade); the inner air guiding device may be connected directly or indirectly to either the inner ring or the outer ring of the one-way bearing; the outer air guiding device may be connected directly or indirectly to either the outer ring or the inner ring of the one-way bearing; the output shaft of the motor may rotate in forward and reverse directions (e.g. in clockwise and counterclockwise directions); when the output shaft of the motor rotates in one direction, the inner air guiding device and the outer air guiding device are driven to rotate simultaneously through the one-way bearing, and when the output shaft of the motor rotates in the other direction, the inner air guiding device or the outer air guiding device is driven to rotate separately through the one-way bearing; in the air outlet, a single motor is used to drive the inner air guiding device and the outer air guiding device to rotate simultaneously or separately when the output shaft rotates forward and reversely, the angle between the inner air guiding device and the outer air guiding device may be adjusted, and the inner air guiding device or the outer air guiding device may be positioned at will.

According to an exemplary embodiment as shown schematically in FIGS. 2, 3A-3B, 4, 4A-4B, 5A-5B, 16, 16A-16C, 24, 25A-25B, 26A-26B and 27A-27F, the air outlet may comprise an inner air guiding device transmission mechanism and an outer air guiding device transmission mechanism, the inner air guiding device being coupled to the inner ring through the inner air guiding device transmission mechanism, and the outer air guiding device being coupled to the outer ring through the outer air guiding device transmission mechanism; by providing the inner air guiding device transmission mechanism and the outer air guiding device transmission mechanism, the inner air guiding device may be coupled to the inner ring, and the outer air guiding device may be coupled to the outer ring.

According to an exemplary embodiment as shown schematically in the FIGS. 2, 3A-3B, 4, 4A-4B, 5A-5B, 16, 16A-16C, 24, 25A-25B, 26A-26B and 27A-27F, the inner air guiding device transmission mechanism may comprise an inner air guiding device connecting rod coupled to a rotating shaft of the inner air guiding device; by providing the inner air guiding device connecting rod, the inner air guiding device may rotate around the rotating shaft along with the movement of the inner air guiding device connecting rod; the inner air guiding device may comprise a plurality of air guiding devices, and in this case, the plurality of air guiding devices may simultaneously rotate around their respective rotating shafts along with the movement of the inner air guiding device connecting rod; the inner air guiding device connecting rod may be connected directly or indirectly to the inner ring of the one-way bearing so as to be driven by the inner ring of the one-way bearing.

According to an exemplary embodiment as shown schematically in FIGS. 2, 3A-3B, 4, 4A-4B, 5A-5B, 16, 16A-16C, 24, 25A-25B, 26A-26B and 27A-27F, the inner air guiding device transmission mechanism may comprise a connecting rod, one end of the connecting rod being coupled to the inner air guiding device, and the other end of the connecting rod being coupled to the inner ring. According to an exemplary embodiment as shown schematically, one end of the connecting rod may be provided with a first connecting rod rotating shaft, and the other end of the connecting rod may be provided with a second connecting rod rotating shaft; the connecting rod may be connected to the inner air guiding device connecting rod through the first connecting rod rotating shaft and coupled to the inner ring through the second connecting rod rotating shaft; by providing the connecting rod, the rotation of the inner ring of the one-way bearing may be converted into the translational movement of the inner air guiding device connecting rod.

According to an exemplary embodiment as shown schematically in FIGS. 2, 3A-3B, 4, 4A-4B, 5A-5B, 16, 16A-16C, 24, 25A-25B, 26A-26B and 27A-27F, the inner air guiding device transmission mechanism may comprise a central shaft, the central shaft may be connected to the inner ring for synchronous rotation, or the central shaft and the inner ring are integrated into one part, and the other end of the connecting rod may be eccentrically connected to the central shaft. According to an exemplary embodiment as shown schematically, the connecting rod may be eccentrically connected to the central shaft through the second connecting rod rotating shaft; by providing the central shaft connected to the inner ring, the coupling of the connecting rod and the inner ring may be facilitated. According to an exemplary embodiment as shown schematically, the output shaft may be coupled to the central shaft; by the coupling of the output shaft and the central shaft, the power transmission from the motor to the inner air guiding device through the central shaft may be facilitated. According to an exemplary embodiment as shown schematically, the outer air guiding device transmission mechanism may comprise an outer air guiding device connecting rod coupled to a rotating shaft of the outer air guiding device; by providing the outer air guiding device connecting rod, the outer air guiding device may rotate around the rotating shaft along with the movement of the outer air guiding device connecting rod; the outer air guiding device may comprise a plurality of air guiding devices; the plurality of air guiding devices may simultaneously rotate around their respective rotating shafts along with the movement of the outer air guiding device connecting rod; the outer air guiding device connecting rod may be connected directly or indirectly to the outer ring of the one-way bearing so as to be driven by the outer ring of the one-way bearing. According to an exemplary embodiment as shown schematically, the outer air guiding device transmission mechanism may comprise a transmission rod, one end of the transmission rod being coupled to the outer air guiding device, and the other end of the transmission rod being coupled to the outer ring. According to an exemplary embodiment as shown schematically, the transmission rod may be provided with a transmission rod rotating shaft, one end of the transmission rod being coupled to the outer air guiding device connecting rod; by providing the transmission rod, the translational movement of the outer air guiding device connecting rod is achieved along with the rotation of the transmission rod around the transmission rod rotating shaft. According to an exemplary embodiment as shown schematically, the transmission rod may be provided with a protrusion, and the outer air guiding device transmission mechanism may comprise a spiral cam provided with a spiral groove, the spiral cam may be connected to the outer ring for synchronous rotation, or the spiral cam and the outer ring are integrated into one part (e.g. with the protrusion fit for moving in the spiral groove); by the matching of the protrusion arranged on the transmission rod and the spiral groove of the spiral cam arranged outside the outer ring, the protrusion moves in the vertical direction along with the rotation of the outer ring, which drives the transmission rod to rotate around the transmission rod rotating shaft to provide the translational movement of the outer air guiding device connecting rod and the rotation of the outer air guiding device around the rotating shaft. See FIGS. 2, 3A-3B, 4, 4A-4B, 5A-5B, 16, 16A-16C, 24, 25A-25B, 26A-26B and 27A-27F.

According to an exemplary embodiment as shown schematically in FIGS. 6 and 27A-27F, the output shaft may be coupled to the inner ring through a gear set; by providing the gear set, the gear ratio may be adjusted, which is favorable to the adjustment of power output of the output shaft to the inner ring. See also FIGS. 2, 3A-3B, 4, 4A-4B, 5A-5B, 16, 16A-16C, 24, 25A-25B and 26A-26B.

According to an exemplary embodiment as shown schematically in FIGS. 2, 3A-3B, 4, 4A-4B, 5A-5B, 16, 16A-16C, 24, 25A-25B, 26A-26B and 27A-27F, the air outlet may comprise a housing provided inside with the inner air guiding device and the outer air guiding device; the housing provided may be useful for forming flow channels in the inner air guiding device and the outer air guiding device, and may also protect the inner air guiding device and the outer air guiding device from inappropriate operation caused by direct contact made by a user with the inner air guiding device and the outer air guiding device. According to an exemplary embodiment, the inner air guiding device may comprise a blade, a roller or a moving block, and the outer air guiding device may comprise a blade, a roller or a moving block; the inner air guiding device may comprise a blade, a roller or a moving block, and the outer air guiding device may comprise a blade, a roller or a moving block; the inner and outer air guiding devices may be combined (e.g. inner and outer air guiding devices may be a combination of blades, a combination of a blade and a roller, or a combination of a moving block and a blade).

According to an exemplary embodiment as shown schematically in FIGS. 2, 3A-3B, 4, 4A-4B, 5A-5B, 16, 16A-16C, 24, 25A-25B, 26A-26B and 27A-27F, the outer air guiding device may comprise a set of outer blades comprising two outer blades arranged in parallel, and each of the outer blades may comprise two hinged blades; air may flow through a flow channel formed between two layers of outer air guiding devices; each layer of the outer air guiding device comprises two blades hinged to each other; flow channels with different orientations may be formed by rotating one of the blades, so that airflow in different directions are obtained; such outer air guiding devices may provide for reduced size of the air outlet and reduced space occupied by the air outlet on the dashboard of a vehicle. See FIGS. 1B and 1C.

According to an exemplary embodiment as shown schematically in FIGS. 2, 3A-3B, 4, 4A-4B, 5A-5B, 16, 16A-16C, 24, 25A-25B, 26A-26B and 27A-27F, a single motor may be used to drive the inner air guiding device and the outer air guiding device to rotate simultaneously or separately when the output shaft rotates forward and reversely, the angle between the inner air guiding device and the outer air guiding device may be adjusted, and the inner air guiding device or the outer air guiding device may be positioned at will. According to an exemplary embodiment as shown schematically, an air outlet may comprise a motor comprising an output shaft, a one-way bearing comprising an inner ring and an outer ring and an inner air guiding device and an outer air guiding device, the inner air guiding device may be coupled to the inner ring and the outer air guiding device may be coupled to the outer ring, or the inner air guiding device may be coupled to the outer ring and the outer air guiding device may be coupled to the inner ring; the output shaft may be coupled to either the inner ring or the outer ring; by means of forward and reverse rotation of the output shaft, the motor may drive the inner air guiding device and the outer air guiding device simultaneously through the one-way bearing and may drive the inner air guiding device or the outer air guiding device separately through the one-way bearing; the air outlet may comprise an inner air guiding device transmission mechanism and an outer air guiding device transmission mechanism, the inner air guiding device being coupled to the inner ring through the inner air guiding device transmission mechanism, and the outer air guiding device being coupled to the outer ring through the outer air guiding device transmission mechanism; the inner air guiding device transmission mechanism may comprise a connecting rod, one end of the connecting rod being coupled to the inner air guiding device, and the other end of the connecting rod being coupled to the inner ring; the inner air guiding device transmission mechanism may comprise a central shaft, the central shaft may be connected to the inner ring for synchronous rotation, or the central shaft and the inner ring are integrated into one part, and the other end of the connecting rod may be eccentrically connected to the central shaft; the output shaft may be coupled to the central shaft; the outer air guiding device transmission mechanism may comprise a transmission rod, one end of the transmission rod being coupled to the outer air guiding device, and the other end of the transmission rod being coupled to the outer ring; the transmission rod may be provided with a protrusion, and the outer air guiding device transmission mechanism may comprise a spiral cam provided with a spiral groove, the spiral cam may be connected to the outer ring for synchronous rotation, or the spiral cam and the outer ring are integrated into one part, and the protrusion is fit for moving in the spiral groove; the output shaft is coupled to the inner ring through a gear set; the inner air guiding device may comprise a blade, a roller or a moving block, and the outer air guiding device may comprise a blade, a roller or a moving block; the outer air guiding device may comprise a set of outer blades comprising two outer blades arranged in parallel, and each of the outer blades may comprise two hinged blades. See FIGS. 2, 3A-3B, 4, 4A-4B, 5A-5B, 16, 16A-16C, 24, 25A-25B, 26A-26B and 27A-27F.

REFERENCE SYMBOL LIST

| | REFERENCE |
|---|---|
| ELEMENT, PART OR COMPONENT | SYMBOL |
| vehicle | V |
| interior | I |
| component | C |
| instrument panel | IP |
| door panel | DP |
| floor console | FC |
| air vent system/assembly | AV |
| user interface | UI |
| operator control | OC |
| drive mechanism | DM |
| clutch mechanism/assembly | CM |
| motor | M |
| airflow control/guide mechanism - inner/vertical | VM |
| airflow control/guide mechanism - outer/horizontal | HM |
| airflow guides/vanes - inner/vertical blade set | VB |
| airflow guides/vanes - outer/horizontal blade set | HB |
| airflow | AF |
| one-way bearing component | 10 |
| central shaft | 11 |
| one-way bearing | 12 |
| spiral cam | 13 |
| transmission gear/central shaft driving gear | 14 |
| motor output gear | 15 |
| front cover | 40 |
| rear cover | 50 |
| motor | 60 |
| key groove | 111 |
| key groove | 112 |
| through-hole | 113 |
| inner ring | 121 |
| brake wedges | 122 |
| spring coil | 123 |
| cage | 124 |
| outer ring | 125 |
| spiral groove | 131 |
| key groove | 132 |
| key | 141 |
| first horizontal lower blade | 201 |
| first horizontal upper blade | 202 |
| second horizontal lower blade | 203 |
| second horizontal upper blade | 204 |
| outer blade connecting rod | 205 |
| transmission rod | 206 |
| vertical blades | 301 |
| inner blade connecting rod | 302 |
| connecting rod | 303 |
| output shaft | 601 |
| output shaft | 601 |
| inner shaft key | 1211 |
| key | 1251 |
| rotating shaft | 2011 |
| rotating shaft | 2021 |
| protrusion | 2061 |
| shaft pin | 2062 |
| transmission rod rotating shaft | 2063 |
| rotating shaft | 3011 |
| first connecting rod rotating shaft | 3031 |
| second connecting rod rotating shaft | 3032 |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. An air vent assembly configured for a vehicle interior comprising:
(a) an inner airflow guide;
(b) an outer airflow guide;
(c) a drive mechanism comprising an inner airflow mechanism configured to actuate the inner airflow guide and an outer airflow mechanism configured to actuate the outer airflow guide;
wherein the drive mechanism is configured to be operated in a first direction and a second direction;
wherein the drive mechanism is configured so that (1) when operated in the first direction the inner airflow mechanism is actuated and (2) when operated in the second direction the inner airflow mechanism is actuated and the outer airflow mechanism is actuated.

2. The assembly of claim 1 further comprising a motor configured to operate the drive mechanism; wherein the motor is configured to operate a shaft to operate the drive mechanism.

3. The assembly of claim 2 wherein operation of the drive mechanism in the first direction comprises rotation of the shaft in the first direction and operation of the drive mechanism in the second direction comprises rotation of the shaft in the second direction.

4. The assembly of claim 1 wherein the drive mechanism comprises a clutch assembly configured to engage at the drive mechanism so that (1) when operated in the first direction only the inner airflow mechanism is actuated and (2) when operated in the second direction both the inner airflow mechanism is actuated and the outer airflow mechanism is actuated.

5. The assembly of claim 4 wherein the clutch assembly comprises an inner ring and an outer ring.

6. The assembly of claim 4 wherein the clutch assembly comprises a one-way bearing.

7. The assembly of claim 1 wherein the inner airflow mechanism comprises a gear and a connecting rod coupled to the inner airflow guide.

8. The assembly of claim 1 wherein the inner airflow mechanism comprises a rack and pinion.

9. The assembly of claim 1 wherein the outer airflow mechanism comprises a cam and a follower coupled to the outer airflow guide.

10. The assembly of claim 9 wherein the cam comprises a spiral cam.

11. The assembly of claim 1 wherein the inner airflow guide is configured to direct airflow in a first airflow direction and the outer airflow guide is configured to direct airflow in a second airflow direction.

12. The assembly of claim 1 wherein the inner airflow guide comprises an inner blade set comprising a plurality of blades; and wherein the outer airflow guide comprises an outer blade set comprising a plurality of blades.

13. The assembly of claim 12 wherein the inner blade set comprises a vertical blade set comprising a plurality of generally vertical blades; and wherein the outer blade set comprises a horizontal blade set comprising a plurality of generally horizontal blades.

14. An air vent system configured for a vehicle interior comprising:
(a) an inner blade set comprising a plurality of blades;
(b) an outer blade set comprising a plurality of blades;
(c) a drive mechanism configured to be operated in a first direction and a second direction;
(d) a motor configured to operate the drive mechanism;
wherein the drive mechanism comprises an inner blade mechanism configured to actuate the inner blade set;
wherein the drive mechanism comprises an outer blade mechanism configured to actuate the outer blade set;
wherein the drive mechanism comprises a clutch mechanism configured to engage the drive mechanism so that (1) when operated in the first direction only the inner blade mechanism is actuated and (2) when operated in the second direction both the inner blade mechanism is actuated and the outer blade mechanism is actuated.

15. The system of claim 14 wherein the clutch mechanism comprises an inner ring and an outer ring; wherein the clutch mechanism is configured so that both the inner ring and the outer ring are engaged when the drive mechanism is operated in the second direction.

16. An air vent assembly configured for a vehicle interior comprising:
(a) a vertical blade set comprising a plurality of generally vertical blades;
(b) a horizontal blade set comprising a plurality of generally horizontal blades;
(c) a drive mechanism configured to be operated in a first direction and a second direction;
wherein the drive mechanism comprises a vertical blade mechanism configured to actuate the vertical blade set;
wherein the drive mechanism comprises a horizontal blade mechanism configured to actuate the horizontal blade set;
wherein the drive mechanism comprises a clutch assembly configured to engage the drive mechanism so that (1) when operated in the first direction the vertical blade mechanism is actuated and (2) when operated in the second direction the vertical blade mechanism is actuated and the horizontal blade mechanism is actuated.

17. The assembly of claim 16 wherein the clutch assembly is configured so that the drive mechanism is operated in the first direction to actuate only the vertical blade mechanism.

18. The assembly of claim 16 wherein the clutch assembly is configured so that the drive mechanism is operated in the second direction both to actuate the vertical blade mechanism and to actuate the horizontal blade mechanism.

19. The assembly of claim 16 wherein the clutch assembly is configured so that the drive mechanism is operated in the second direction to actuate the vertical blade mechanism and to actuate the horizontal blade mechanism synchronously with a one-to-one drive ratio.

20. The assembly of claim 16 further comprising a motor configured to operate the drive mechanism; wherein the motor is configured to operate a shaft to operate the drive mechanism; wherein operation of the drive mechanism in the first direction comprises rotation of the shaft in the first direction and operation of the drive mechanism in the second direction comprises rotation of the shaft in the second direction.
